(19) United States
(12) Patent Application Publication
(10) Pub. No.: US 2017/0254644 A1
(43) Pub. Date: Sep. 7, 2017

(54) DRIVE CIRCUIT, ANGULAR VELOCITY DETECTION DEVICE, ELECTRONIC APPARATUS, AND MOVING OBJECT

(71) Applicant: Seiko Epson Corporation, Tokyo (JP)

(72) Inventor: Kei KANEMOTO, Fujimi (JP)

(21) Appl. No.: 15/444,721

(22) Filed: Feb. 28, 2017

(30) Foreign Application Priority Data
Mar. 4, 2016 (JP) 2016-042348

(51) Int. Cl. G01C 19/5726; G01C 19/5747

(52) U.S. Cl. CPC G01C 19/5726; G01C 19/5747

(57) ABSTRACT

A drive circuit includes a first converter that includes a first operational amplifier and a first capacitance, accumulates first signals output from a first electrode of an angular velocity detection element and input to the first operational amplifier in the first capacitance, and then, converts the signals to a voltage, a first phase adjustment portion that adjusts a phase of the drive signal which drives the angular velocity detection element and limits a frequency band of the drive signal based on the output signals from the first converter, and a drive signal generation portion that generates the drive signal based on the output signals from the first phase adjustment portion.

### BACKGROUND

1. Technical Field

The present invention relates to a drive circuit, an angular velocity detection device, an electronic apparatus, and a moving object.

2. Related Art

Various electronic apparatuses and systems are widely used, on which an angular velocity detection device (a Gyro sensor) is mounted and which perform predetermined controls based on a detected angular velocity. In JP-A-2014-197010, an angular velocity detection device is disclosed which includes a drive circuit that converts a current output from a sensor element made of quartz crystal to a voltage signal using an I/V conversion circuit and adjusts amplitude of a drive signal which drives the sensor element such that the amplitude of the voltage signal becomes constant.

Incidentally, recent years, an angular velocity detection device that detects the angular velocity using a silicon micro-electromechanical system (MEMS) technology has been developed. The angular velocity detection device using the silicon MEMS technology has an advantage of being realized at a low cost because there is no need to form the sensor element by processing the crystal as the angular velocity detection device disclosed in JP-A-2014-197010.

However, in the angular velocity detection device using the silicon MEMS technology, a current (detection signal) output from the sensor element is extremely small compared to the current output from the sensor element made of crystal disclosed in JP-A-2014-197010. Therefore, if this extremely small amount of current is received by the I/V conversion circuit disclosed in JP-A-2014-197010, the current cannot be sufficiently amplified and an S/N ratio of the voltage signal after conversion is reduced, and thus, jitters of the drive signal increase. Then, since a reference signal input to a synchronous detection circuit included in an angular velocity detection circuit is generated based on the drive signal, consequently, an accuracy of detection by the angular velocity detection device deteriorates.

### SUMMARY

An advantage of some aspects of the invention is to provide a drive circuit that can reduce the jitters of the drive signal. In addition, according to some aspects of the invention, it is possible to provide an angular velocity detection device capable of improving the accuracy of detecting the angular velocity. In addition, according to some aspects of the invention, it is possible provide an electronic apparatus and a moving object that use the angular velocity detection device.

The invention can be realized by aspects or application examples described below.

### Application Example 1

A drive circuit according to this application example includes: a first converter that includes a first operational amplifier and a first capacitance, accumulates first signals output from a first electrode of an angular velocity detection element and input to the first operational amplifier in the first capacitance, and then, converts the signals to a voltage; a first phase adjustment portion that adjusts a phase of the drive signal which drives the angular velocity detection element and limits a frequency band of the drive signal based on the output signals from the first converter; and a drive signal generation portion that generates the drive signal based on the output signals from the first phase adjustment portion.

In the drive circuit according to the application example, the first converter coverts the signals to the voltage not by causing the first signal flow through the resistor but by accumulating the first signal in the first capacitance. Therefore, it is possible to sufficiently amplify the first signal despite that the first signal is small. The signal sufficiently amplified in the first converter is in advance of the first signal in phase. Therefore, in the first phase adjustment portion, the vibration condition can be satisfied after the phase adjustment and the noise component is attenuated by limiting the frequency band, and thus, it is possible to improve the S/N ratio. The drive signal generation portion generates the drive signal that drives the angular velocity detection element based on the output signals from the first phase adjustment portion of which the S/N ratio is improved. Therefore, it is possible to reduce the jitter of the drive signal.

### Application Example 2

In the drive circuit according to the application example described above, the first phase adjustment portion may include a first phase shift circuit for adjusting the phase of the drive signal and a first filter for limiting the frequency band of the drive signal.

According to the drive circuit in the application example, the phase adjustment of the drive signals by the first phase shift circuit and the limiting the frequency band of the drive signal by the first filter can be performed independently. Therefore, it is easy to design the circuit, and thus, it is possible to realize the reduction of the area of the circuit and the stable vibration operation.

### Application Example 3

In the drive circuit according to the application example described above, the first phase shift circuit may be an all pass filter.

According to the drive circuit in the application example, the amplitude of the output signals from the first converter is not attenuated even though the signals pass through the first phase shift circuit. Therefore, it is possible to maintain the high S/N ratio.

### Application Example 4

In the drive circuit according to the application example described above, the first filter may be a low pass filter.

According to the drive circuit in the application example, the high frequency noise of the output signals from the first converter is attenuated when the signals pass through the first filter. Therefore, it is possible to improve the S/N ratio.

### Application Example 5

In the drive circuit according to the application example described above, the first filter may be provided at a stage subsequent to the first phase shift circuit.

According to the drive circuit in the application example, when the output signals from the first converter pass through the first phase shift circuit, the noise is attenuated by the first filter even if the noises generated in the first phase shift circuit are superimposed. Therefore, it is possible to improve the S/N ratio.

### Application Example 6

The drive circuit according to the application example described above may further include: a second converter that includes a second operational amplifier and a second capacitance, accumulates second signals output from a second electrode of the angular velocity detection element and input to the second operational amplifier in the second capacitance, and then, converts the signals to a voltage; and a second phase adjustment portion that adjusts a phase of the drive signal and limits a frequency band of the drive signal based on the output signals from the second converter. The drive signal generation portion may generate the drive signal based on the output signals from the first phase adjustment portion and the output signals from the second phase adjustment portion.

In the drive circuit according to the application example, the first converter converts the first signal to the voltage by accumulating the first signal in the first capacitance and the second converter converts the second signal to the voltage by accumulating the second signal in the second capacitance. Therefore, it is possible to sufficiently amplify the first signal and the second signal despite that the signals are small. The signal sufficiently amplified in the first converter is in advance of the first signal in phase. Therefore, in the first phase adjustment portion, the vibration condition can be satisfied after the phase adjustment and the noise component is attenuated by limiting the frequency band, and thus, it is possible to improve the S/N ratio. Similarly, the signal sufficiently amplified in the second converter is in advances of the second signal in phase. Therefore, in the second phase adjustment portion, the vibration condition can be satisfied after the phase adjustment and the noise component is attenuated by limiting the frequency band, and thus, it is possible to improve the S/N ratio. The drive signal generation portion generates the drive signal that drives the angular velocity detection element based on the output signals from the first phase adjustment portion and the output signals from the second phase adjustment portion, of which the S/N ratio is improved. Therefore, it is possible to reduce the jitter of the drive signal.

The second phase adjustment portion may include a second phase shift circuit for adjusting the phase of the drive signal and a second filter for limiting the frequency band of the drive signal. The second phase shift circuit may be an all pass filter. The second filter may be a low pass filter. The second filter may be provided at the state subsequent to the second phase shift circuit.

### Application Example 7

In the drive circuit according to the application example described above, the drive signal generation portion may include; a comparator that compares a voltage of the output signal from the first phase adjustment portion and the voltage of the output signal from the second phase adjustment portion, and a level conversion circuit that converts a voltage level of the output signals from the comparator and generates the drive signal.

### Application Example 8

An angular velocity detection device according to this application example includes: any one of the drive circuits described above; an angular velocity detection circuit that receives a detection signal output from the angular velocity detection element and generates an angular velocity signal; and the angular velocity detection element.

According to the angular velocity detection device in the application example, the device includes the drive circuit which is capable of reducing the jitter of the drive signals. Therefore, it is possible to improve the accuracy of detecting the angular velocity.

### Application Example 9

An electronic apparatus according to this application example includes the angular velocity detection device described above.

### Application Example 10

A moving object in this application example includes the angular velocity detection device described above.

According to the application examples, the angular velocity detection device which is capable of improving the accuracy of detecting the angular velocity is provided. Therefore, it is possible to realize the electronic apparatus and the moving object that can perform the processing items based on the change of the angular velocity with a high accuracy.

### BRIEF DESCRIPTION OF THE DRAWINGS

The invention will be described with reference to the accompanying drawings, wherein like numbers reference like elements.

FIG. 1 is a plan view schematically illustrating an angular velocity detection element.

FIG. 2 is a sectional view schematically illustrating the angular velocity detection element.

FIG. 3 is a diagram for describing an operation of the angular velocity detection element.

FIG. 4 is a diagram for describing an operation of the angular velocity detection element.

FIG. 5 is a diagram for describing an operation of the angular velocity detection element.

FIG. 6 is a diagram for describing an operation of the angular velocity detection element.

FIG. 7 is a diagram illustrating a configuration of the angular velocity detection device in the embodiment.

FIG. 8 is a diagram illustrating an example of frequency characteristics of a phase shift circuit which is an all pass filter.

FIG. 9 is a diagram illustrating an example of frequency characteristics of a band limiting filter which is a low pass filter.

FIG. 10 is a diagram illustrating an example of a signal waveform in the angular velocity detection device in the embodiment.

FIG. 11 is a diagram illustrating a configuration of an angular velocity detection device in the modification example 1.

FIG. 12 is a functional block diagram of an electronic apparatus in the embodiment.

FIG. 13A is a diagram illustrating an example of an external view of a smart phone which is an example of the electronic apparatus.

FIG. 13B is a diagram illustrating an example of an external view of a wrist-wearable type mobile device which is an example of the electronic apparatus.

FIG. 14 is a diagram (top view) illustrating an example of a moving object in the embodiment.

### DESCRIPTION OF EXEMPLARY EMBODIMENTS

Hereinafter, preferable embodiments of the invention will be described with reference to the drawings. The embodiments described below do not unreasonably limit the content of the invention described in the aspects of the invention. In addition, entire of the configurations described below are not always the essentially required configuration of the invention.

### 1. Angular Velocity Detection Device

### Configuration and Operation of an Angular Velocity Detection Element

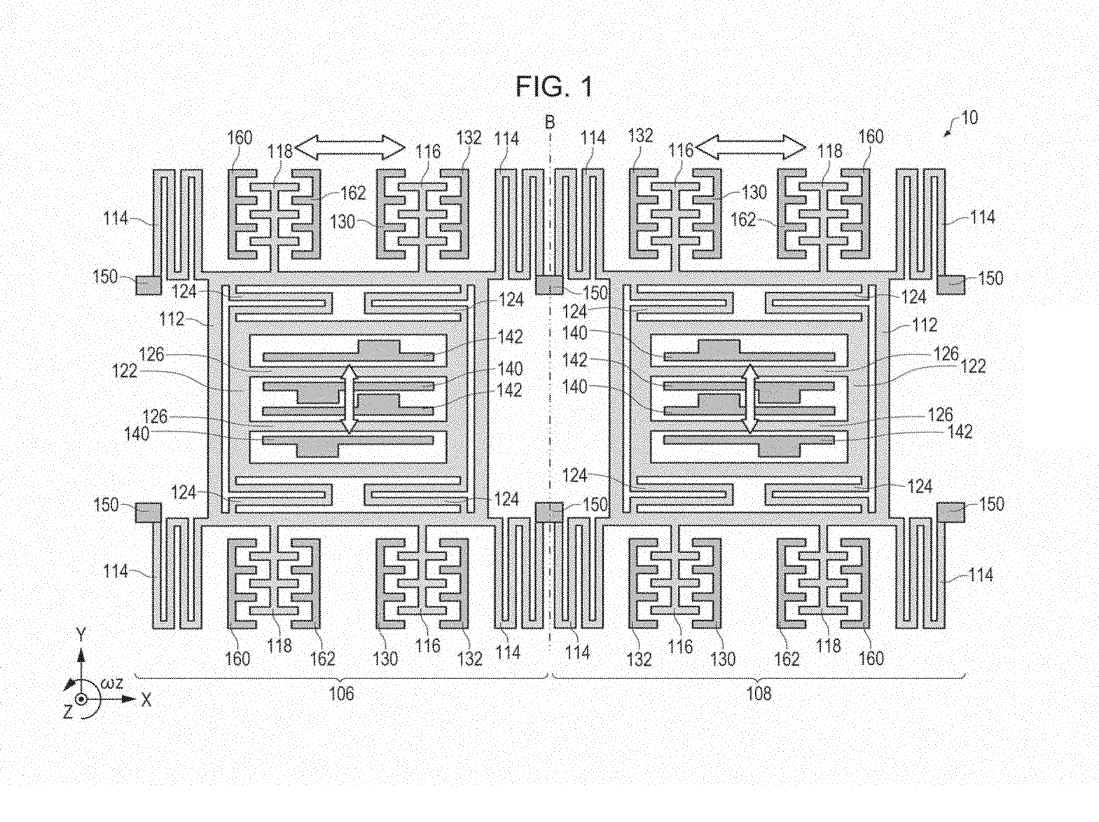

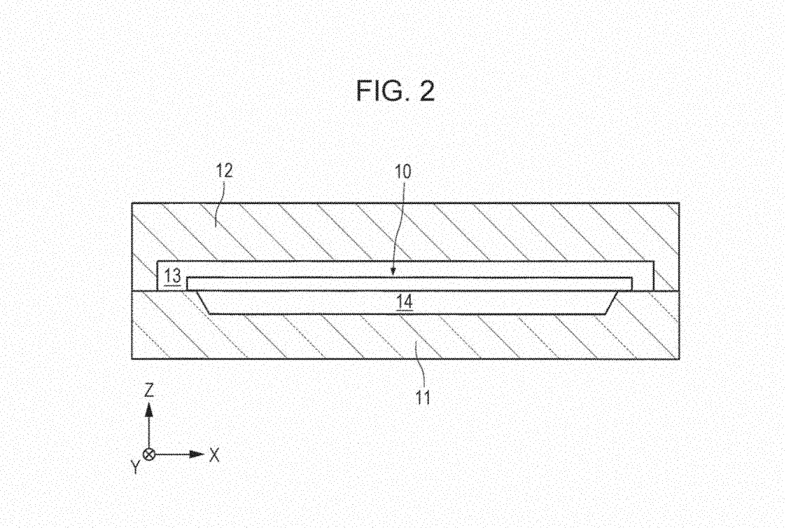

First, an angular velocity detection element 10 included in an angular velocity detection device 1 in the embodiment will be described with reference to the drawings. FIG. 1 is a plan view schematically illustrating the angular velocity detection element 10. FIG. 2 is a sectional view schematically illustrating the angular velocity detection element 10. Axes X, Y, and Z are illustrated in FIG. 1 as three axes orthogonal to each other. Hereinafter, an example will be described, in which the angular velocity detection element 10 is an electrostatic capacitance type MEMS element that detects an angular velocity around the Z axis.

As illustrated in FIG. 2, the angular velocity detection element 10 is provided on a substrate 11 and accommodated in a housing portion configured with the substrate 11 and a rid 12. A cavity 13 that is an inside space of the housing portion is, for example, sealed in vacuum. A material for the substrate 11 is, for example, glass or silicon. A material for the rid 12 is, for example, silicon or glass.

As illustrated in FIG. 1, the angular velocity detection element 10 is configured to include a vibration body 112, a fixed drive electrode 130 and a fixed drive electrode 132, a movable drive electrode 116, a fixed monitor electrode 160 and a fixed monitor electrode 162, a movable monitor electrode 118, a fixed detection electrode 140 and a fixed detection electrode 142, and a movable detection electrode 126.

As illustrated in FIG. 1, the angular velocity detection element 10 includes a first structural body 106 and a second structural body 108. The first structural body 106 and the second structural body 108 are connected to each other along the X axis. The first structural body 106 is positioned at the −X direction side of the second structural body 108. The structural bodies 106 and 108 have a symmetrical shape with respect to a boundary line B (a straight line along the Y axis) thereof. Although it is not illustrated, the angular velocity detection element 10 may be configured to include the first structural body 106 without having the second structural body 108.

Each of the structural bodies 106 and 108 includes a vibration body 112, a first spring portion 114, the movable drive electrode 116, a displacement portion 122, a second spring portion 124, fixed drive electrodes 130 and 132, movable vibration detection electrodes 118 and 126, fixed vibration detection electrodes 140, 142, 160, and 162, and a fixed portion 150. The movable vibration detection electrodes 118 and 126 are divided into the movable monitor electrode 118 and the movable detection electrode 126. The fixed vibration detection electrodes 140, 142, 160, and 162 are divided into the fixed detection electrodes 140 and 142 and the fixed monitor electrodes 160 and 162.

The vibration body 112, the spring portions 114 and 124, the movable drive electrode 116, the movable monitor electrode 118, the displacement portion 122, the movable detection electrode 126, and the fixed portion 150 are integrally formed, for example, by processing the silicon substrate (not illustrated) bonded on the substrate 11. In this way, a fine processing technology used in the manufacturing of a silicon semiconductor device can be applied, and thus, it is possible to achieve the miniaturization of the angular velocity detection element 10. A material for the angular velocity detection element 10 is, for example, silicon doped with impurities such as phosphorus, boron, or the like having a high conductivity, and thus, having a high conductivity. The movable drive electrode 116, the movable monitor electrode 118, and the movable detection electrode 126 may be provided on a surface of the vibration body 112 as members separate from the vibration body 112.

The vibration body 112 has a shape of a frame. The displacement portion 122, the movable detection electrode 126, and the fixed detection electrodes 140 and 142 are provided inside of the vibration body 112.

One end of the first spring portion 114 is connected to the vibration body 112 and the other end is connected to the fixed portion 150. The fixed portion 150 is fixed on the substrate 11. That is, a recess portion 14 (refer to FIG. 2) is provided at the lower portion of the fixed portion 150. The vibration body 112 is supported by the fixed portion 150 via the first spring portion 114. In the illustrated example, four first spring portions 114 are provided on the first structural body 106 and the second structural body 108 respectively. The fixed portion 150 on the boundary line B between the first structural body 106 and the second structural body 108 may not be provided.

The first spring portion 114 is configured so as to displace the vibration body 112 in the X axis direction. Specifically, the first spring portion 114 has a shape to extend to the X axis direction (along the X axis) while reciprocating in the Y axis direction (along the Y axis). The number of first spring portions 114 is not particularly limited as long as the first spring portion 114 can vibrate the vibration body 112 along the X axis.

The movable drive electrode 116 is connected to the vibration body 112. The movable drive electrode 116 extends in the +Y direction and the −Y direction from the vibration body 112. The movable drive electrodes 116 may be provided in plural and the plurality of movable drive electrodes 116 may be arranged in the X axis direction. The movable drive electrode 116 can vibrate along the X axis along with the vibration of the vibration body 112.

The fixed drive electrodes 130 and 132 are fixed on the substrate 11 and provided on the +Y direction side of the vibration body 112 and the −Y direction side of the vibration body 112.

The fixed drive electrodes 130 and 132 are provided so as to face the movable drive electrode 116 while the movable drive electrode 116 being interposed therebetween. Specifically, in the fixed drive electrodes 130 and 132 between which the movable drive electrode 116 is interposed, in the first structural body 106, the fixed drive electrode 130 is provided in the −X direction side of the movable drive electrode 116 and the fixed drive electrode 132 is provided in the +X direction side of the movable drive electrode 116. In the second structural body 108, the fixed drive electrode 130 is provided in the +X direction side of the movable drive electrode 116 and the fixed drive electrode 132 is provided in the −X direction side of the movable drive electrode 116.

In the example illustrated in FIG. 1, the fixed drive electrodes 130 and 132 have a comb tooth shape, and the movable drive electrode 116 has a shape that can be inserted between the comb teeth of the fixed drive electrodes 130 and 132. The fixed drive electrodes 130 and 132 may be provided in plural according to the number of the movable drive electrodes 116 and may be arranged in the X axis direction. The fixed drive electrodes 130 and 132 and the movable drive electrodes 116 are the electrodes for vibrating the vibration body 112.

The movable monitor electrode 118 is connected to the vibration body 112. The movable monitor electrode 118 extends in the +Y direction and the −Y direction from the vibration body 112. In the example illustrated in FIG. 1, each of the movable monitor electrode 118 is provided on the +Y direction side of the vibration body 112 in the first structural body 106 and on the +Y direction side of the vibration body 112 in the second structural body 108, and a plurality of movable drive electrodes 116 are arranged between the two movable monitor electrodes 118. Furthermore, each of the movable monitor electrodes 118 is provided on the −Y direction side of the vibration body 112 in the first structural body 106 and on the −Y direction side of the vibration body 112 in the second structural body 108, and a plurality of movable drive electrodes 116 are arranged between the two movable monitor electrodes 118. The planar shape of the movable monitor electrode 118 is, for example, the same as the planar shape of the movable drive electrode 116. The movable monitor electrode 118 can vibrate, that is, can reciprocate along the X axis along with the vibration of the vibration body 112.

The fixed monitor electrodes 160 and 162 are fixed on the substrate 11 and provided on the +Y direction side of the vibration body 112 and the −Y direction side of the vibration body 112.

The fixed monitor electrodes 160 and 162 are provided so as to face the movable monitor electrode 118 while the movable monitor electrode 118 being interposed therebetween. Specifically, in the fixed monitor electrodes 160 and 162 between which the movable monitor electrode 118 is interposed, in the first structural body 106, the fixed monitor electrode 160 is provided on the −X direction side of the movable monitor electrode 118 and the fixed monitor electrode 162 is provided on the +X direction side of the movable monitor electrode 118. In the second structural body 108, the fixed monitor electrode 160 is provided on the +X direction side of the movable monitor electrode 118 and the fixed monitor electrode 162 is provided on the −X direction side of the movable monitor electrode 118.

The fixed monitor electrodes 160 and 162 have a comb tooth shape, and the movable monitor electrode 118 has a shape that can be inserted between the comb teeth of the fixed monitor electrodes 160 and 162.

The fixed monitor electrodes 160 and 162 and the movable monitor electrode 118 are electrodes for detecting the signals that are changed according to the vibration of the vibration body 112 and the electrodes for detecting a vibration state of the vibration body 112. Specifically, an electrostatic capacitance between the movable monitor electrode 118 and the fixed monitor electrode 160 and an electrostatic capacitance between the movable monitor electrode 118 and the fixed monitor electrode 162 are changed by the movable monitor electrode 118 being displaced along the X axis. In this way, the currents in the fixed monitor electrodes 160 and 162 are changed. It is possible to detect the vibration state of the vibration body 112 by detecting the changes of the current.

The displacement portion 122 is connected to the vibration body 112 via the second spring portion 124. In the illustrated example, the planar shape of the displacement portion 122 is a rectangular shape with the long side along the Y axis. Although not illustrated, the displacement portion 122 may be provided on the outside of the vibration body 112.

The second spring portion 124 is configured so as to displace the displacement portion 122 in the Y axis direction. Specifically, the second spring portion 124 has a shape of extending in the Y axis direction while reciprocating in the X axis direction. The number of the second spring portions 124 is not particularly limited as long as the second spring portions 124 can displace the displacement portion 122 along the Y axis.

The movable detection electrode 126 is connected to the displacement portion 122. For example, the movable detection electrode 126 is provided in plural. The movable detection electrode 126 extends along the +X direction and the −X direction from the displacement portion 122.

The fixed detection electrodes 140 and 142 are fixed on the substrate 11. Specifically, each of one ends of the fixed detection electrodes 140 and 142 is fixed on the substrate 11 and each of the other ends extends to the displacement portion 122 as free ends.

The fixed detection electrodes 140 and 142 are provided so as to face the movable detection electrode 126 while movable detection electrode 126 being interposed therebetween. Specifically, in the fixed detection electrodes 140 and 142 between which the movable detection electrode 126 is interposed, in the first structural body 106, the fixed detection electrode 140 is provided in the −Y direction side of the movable detection electrode 126 and the fixed detection electrode 142 is provided in the +Y direction side of the movable detection electrode 126. In the second structural body 108, the fixed detection electrode 140 is provided in the +Y direction side of the movable detection electrode 126 and the fixed detection electrode 142 is provided in the −Y direction side of the movable detection electrode 126.

In the example illustrated in FIG. 1, the fixed detection electrodes 140 and 142 are provided in plural and are alternately arranged along the Y axis. The fixed detection electrodes 140 and 142 and the movable detection electrode 126 are electrodes for detecting the signals (the electrostatic capacitance) that are changed according to the vibration of the vibration body 112.

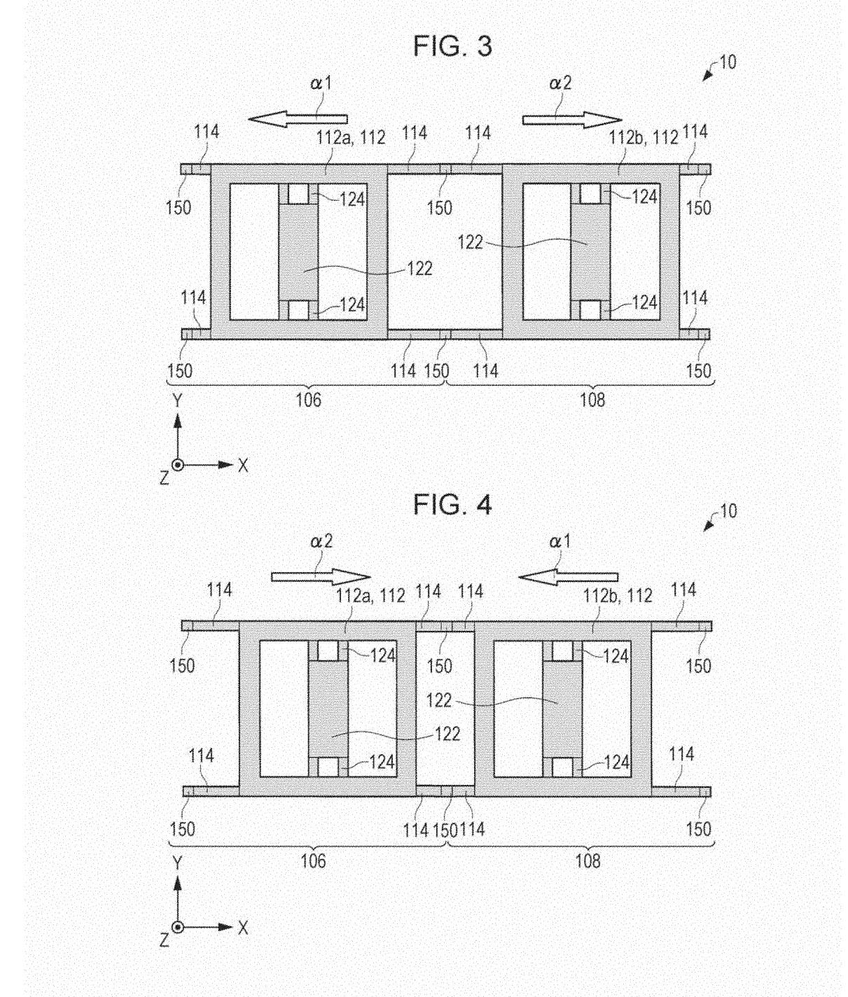

Next, operations of the angular velocity detection element 10 will be described. FIG. 3 to FIG. 6 are diagrams for describing operations of the angular velocity detection element 10. In FIG. 3 to FIG. 6, the axes X, Y, and Z are illustrated as three axes orthogonal to each other. In addition, for the convenience, in FIG. 3 to FIG. 6, the angular velocity detection element 10 is illustrated in a simplified manner while omitting the illustration of the movable drive electrode 116, the movable monitor electrode 118, the movable detection electrode 126, the fixed drive electrodes 130 and 132, the fixed detection electrodes 140 and 142, and the fixed monitor electrodes 160 and 162.

When a voltage is applied between the movable drive electrode 116 and the fixed drive electrodes 130 and 132 using a (not illustrated) power source, an electrostatic force can be generated between the movable drive electrode 116 and the fixed drive electrodes 130 and 132 (refer to FIG. 1). In this way, as illustrated in FIG. 3 and FIG. 4, the first spring portion 114 can expand and contract along the X axis and the vibration body 112 can vibrate along the X axis.

Specifically, a certain bias voltage Vr is given to the movable drive electrode 116. Furthermore, a first AC voltage is applied to the fixed drive electrode 130 via a (not illustrated) drive wiring with a predetermined voltage as a reference. In addition, a second AC voltage of which the phase is shifted by 180° from the first AC voltage is applied to the fixed drive electrode 132 via a (not illustrated) drive wiring with the predetermined voltage as a reference.

Here, in the fixed drive electrodes 130 and 132 between which the movable drive electrode 116 is interposed, in the first structural body 106, the fixed drive electrode 130 is provided in the −X direction side of the movable drive electrode 116 and the fixed drive electrode 132 is provided in the +X direction side of the movable drive electrode 116 (refer to FIG. 1). In the second structural body 108, the fixed drive electrode 130 is provided in the +X direction side of the movable drive electrode 116 and the fixed drive electrode 132 is provided in the −X direction side of the movable drive electrode 116 (refer to FIG. 1). Therefore, it is possible to vibrate the vibration body 112a in the first structural body 106 and the vibration body 112b in the second structural body 108 along the X axis in the phases opposite to each other and in a predetermined frequency using the first AC voltage and the second AC voltage. In the example illustrated in FIG. 3, the vibration body 112a is displaced in a direction α1 and the vibration body 112b is displaced in a direction α2 opposite to the direction α1. In the example illustrated in FIG. 4, the vibration body 112a is displaced in a direction α2 and the vibration body 112b is displaced in a direction α1.

The displacement portion 122 is displaced along the X axis along with the vibration of the vibration body 112. Similarly, the movable detection electrode 126 (refer to FIG. 1) is displaced along the X axis along with the vibration of the vibration body 112.

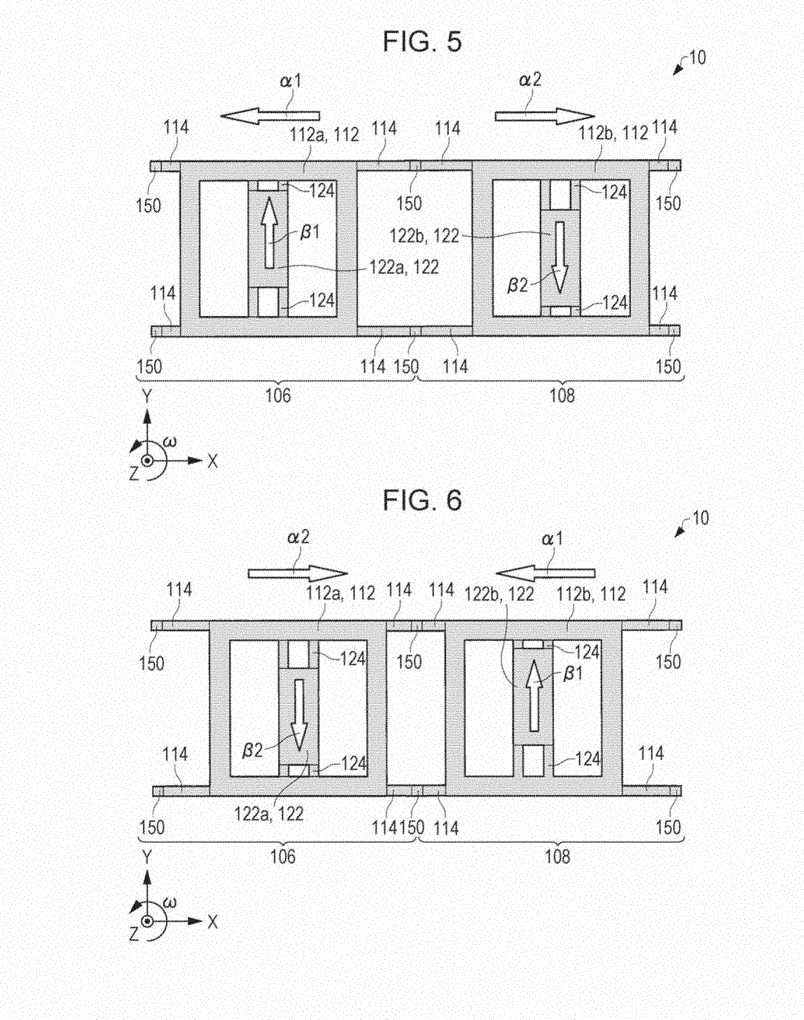

As illustrated in FIG. 5 and FIG. 6, when an angular velocity w around the Z axis is applied to the angular velocity detection element 10 in a state in which the vibration bodies 112a and 112b vibrate along the X axis, the Coriolis force works, and thus, the displacement portion 122 is displaced along the Y axis. That is, the displacement portion 122a connected to the vibration body 112a and the displacement portion 122b connected to the vibration body 112b are respectively displaced along the Y axis to the directions opposite to each other. In the example illustrated in FIG. 5, the displacement portion 122a is displaced in a direction β1 and the displacement portion 122b is displaced in a direction β2 opposite to the direction β1. In the example illustrated in FIG. 6, the displacement portion 122a is displaced in the direction β2 and the displacement portion 122b is displaced in the direction β1.

A distance between the movable detection electrode 126 and the fixed detection electrode 140 is changed by the displacement portions 122a and 122b being displaced along the Y axis (refer to FIG. 1.). Similarly, a distance between the movable detection electrode 126 and the fixed detection electrode 142 is changed (refer to FIG. 1). Therefore, the electrostatic capacitance between the movable detection electrode 126 and the fixed detection electrode 140 is changed. Similarly, the electrostatic capacitance between the movable detection electrode 126 and the fixed detection electrode 142 is changed.

In the angular velocity detection element 10, it is possible to detect an amount of change of the electrostatic capacitance between the movable detection electrode 126 and the fixed detection electrode 140 by applying the voltage between the movable detection electrode 126 and the fixed detection electrode 140 (refer to FIG. 1). Furthermore, it is possible to detect an amount of change of the electrostatic capacitance between the movable detection electrode 126 and the fixed detection electrode 142 by applying the voltage between the movable detection electrode 126 and the fixed detection electrode 142 (refer to FIG. 1). In this way, the angular velocity detection element 10 can obtain the angular velocity ω around the Z axis using the amount of change of the electrostatic capacitance between the movable detection electrode 126 and the fixed detection electrodes 140 and 142.

Furthermore, in the angular velocity detection element 10, a distance between the movable monitor electrode 118 and the fixed monitor electrode 160 is changed by the vibration bodies 112a and 112b vibrating along the X axis (refer to FIG. 1). Similarly, a distance between the movable monitor electrode 118 and the fixed monitor electrode 162 is changed (refer to FIG. 1). Therefore, the electrostatic capacitance between the movable monitor electrode 118 and the fixed monitor electrode 160 is changed. Similarly, the electrostatic capacitance between the movable monitor electrode 118 and the fixed monitor electrode 162 is changed. Along with this, the current flowing in the fixed monitor electrodes 160 and 162 is changed. It is possible to detect (monitor) the vibration state of the vibration bodies 112a and 112b using this change of the current.

In the angular velocity detection element 10, as in the example illustrated in FIG. 1, the fixed detection electrodes 140 and 142 may be provided on regions on both sides of the reciprocating ends of the movable detection electrode 126.

### Configuration and Operation of an Angular Velocity Detection Device

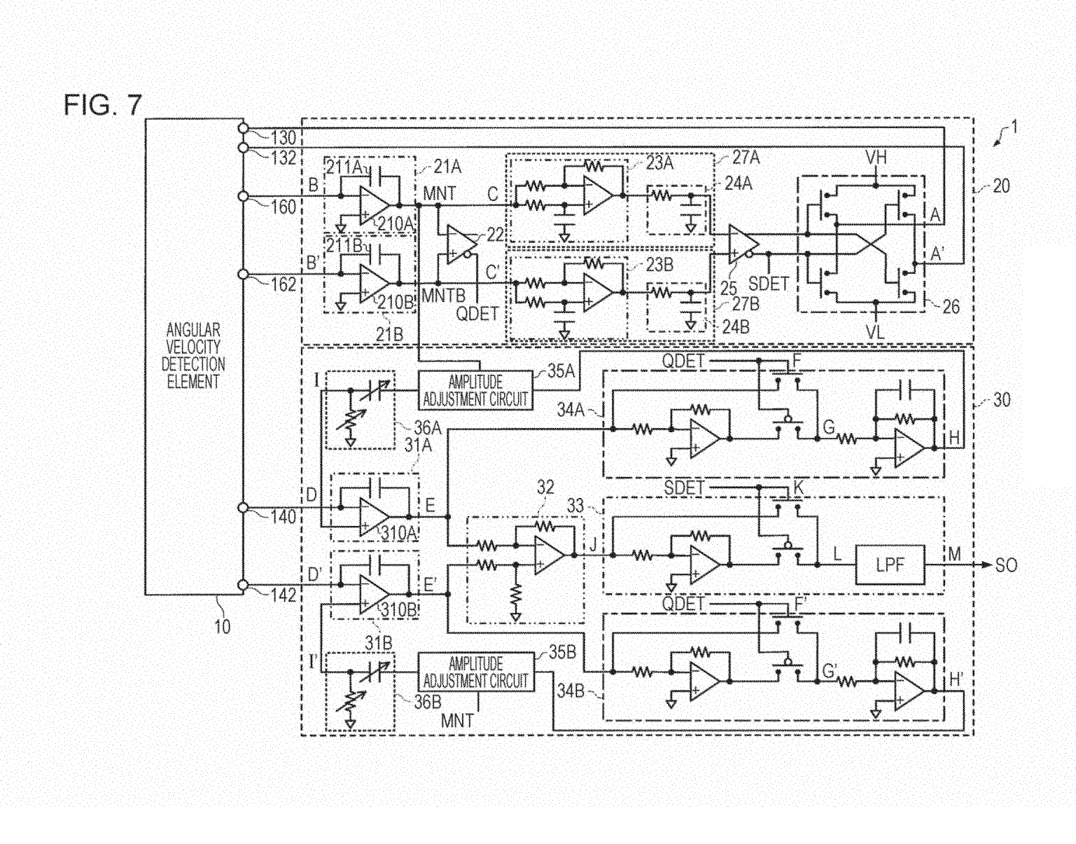

FIG. 7 is a diagram illustrating a configuration of the angular velocity detection device 1 in the embodiment. As illustrated in FIG. 7, the angular velocity detection device 1 in the embodiment is configured to include the angular velocity detection element 10 illustrated in FIG. 1, a drive circuit 20, and an angular velocity detection circuit 30.

The drive circuit 20 generates a drive signal based on the signal from the fixed monitor electrodes 160 and 162 in the angular velocity detection element 10, and outputs the drive signal to the fixed drive electrodes 130 and 132. The drive circuit 20 outputs the drive signal and drives the angular velocity detection element 10, and then, receives a feedback signal from the angular velocity detection element 10. In this way, the angular velocity detection element 10 is excited to vibrate.

The angular velocity detection circuit 30 receives the detection signal output from the angular velocity detection element 10 driven by the drive signal, and attenuates a vibration-based quadrature signal (a leakage signal) from the detection signal, and then, generates an angular velocity signal SO by extracting the Coriolis force-based Coriolis signal.

The drive circuit 20 in the embodiment is configured to include two Q/V converters (charge amplifiers) 21A and 21B, a comparator 22, two phase shift circuits 23A and 23B, two band limiting filters 24A and 24B, a comparator 25, and a level conversion circuit 26.

When the vibration body 112 in the angular velocity detection element 10 vibrates, the mutually reverse-phased currents based on the change of the capacitance are output from the fixed monitor electrodes 160 and 162 as the feedback signal.

The Q/V converter 21A (an example of a first converter) includes an operational amplifier 210A (an example of a first operational amplifier) and a capacitor 211A (an example of a first capacitance), and accumulates the currents (electric charges) (an example of a first signal) output from the fixed monitor electrode 160 (an example of a first electrode) in the angular velocity detection element 10 and input to an inverting input terminal of the operational amplifier 210A in the capacitor 211A, and then, converts the currents to the voltage. Similarly, the Q/V converter 31B (an example of a second converter) includes an operational amplifier 210B (an example of a second operational amplifier) and a capacitor 211B (an example of a second capacitance), and accumulates the currents (electric charges) (an example of a second signal) output from the fixed monitor electrode 162 (an example of a second electrode) in the angular velocity detection element 10 and input to an inverting input terminal of the operational amplifier 210B in the capacitor 211B, and then, converts the currents to the voltage. Specifically, the Q/V converters 21A and 21B convert the input current (the electric charges) to a voltage with an analog ground voltage AGND as a reference, and output AC voltage signals MNT and MNTB having the frequency same as the vibration frequency of the vibration body 112. The AC voltage signals MNT and MNTB are the signals of which the phases are in advance of the AC currents output from the fixed monitor electrodes 160 and 162 in phase by 90° respectively.

The AC voltage signals MNT and MNTB respectively output from the Q/V converters 21A and 21B are input to the comparator 22. The comparator 22 compares the voltage of the AC voltage signal MNT and the voltage of the AC voltage signal MNTB, and outputs mutually reverse-phased square wave signals from a non-inverting output terminal and the inverting output terminal. In the example in FIG. 7, the square wave signal output from the inverting output terminal of the comparator 22 is used as a quadrature reference signal QDET described below. When the voltage of the AC voltage signal MNT is higher than the voltage of the AC voltage signal MNTB, the quadrature reference signal QDET is in a high level. When the voltage of the AC voltage signal MNT is lower than the voltage of the AC voltage signal MNTB, the quadrature reference signal QDET is in a low level.

In addition, the AC voltage signals MNT and MNTB are respectively input to the phase shift circuits 23A and 23B. The phase shift circuit 23A (an example of a first phase shift circuit) is a circuit for adjusting the phase of the drive signal, and outputs a signal in which the phase of the AC voltage signal MNT is shifted. Similarly, the phase shift circuit 23B (an example of a second phase shift circuit) is a circuit for adjusting the phase of the drive signal, and outputs a signal in which the phase of the AC voltage signal MNTB is shifted. In the example in FIG. 7, the phase shift circuits 23A and 23B are all pass filters that pass the signals of the entire frequency bands, but may be circuits other than those.

The output signals from the phase shift circuits 23A and 23B are respectively input to the band limiting filters 24A and 24B. The band limiting filter 24A (an example of a first filter) is a circuit for limiting the frequency band of the drive signal, and passes the signals having the frequency matching the frequency included in the output signal from the phase shift circuit 23A and attenuates the noise signal. Similarly, the band limiting filter 24B (an example of a second filter) is a circuit for limiting the frequency band of the drive signal, and passes the signals having the frequency matching the frequency included in the output signal from the phase shift circuit 23B and attenuates the noise signal. Particularly, in the example in FIG. 7, in order to attenuate the noise signal in the high frequency band, the band limiting filters 24A and 24B are the low pass filters. However, in order to attenuate the noise signal in the low frequency band as well, the band limiting filters 24A and 24B may be the band pass filters.

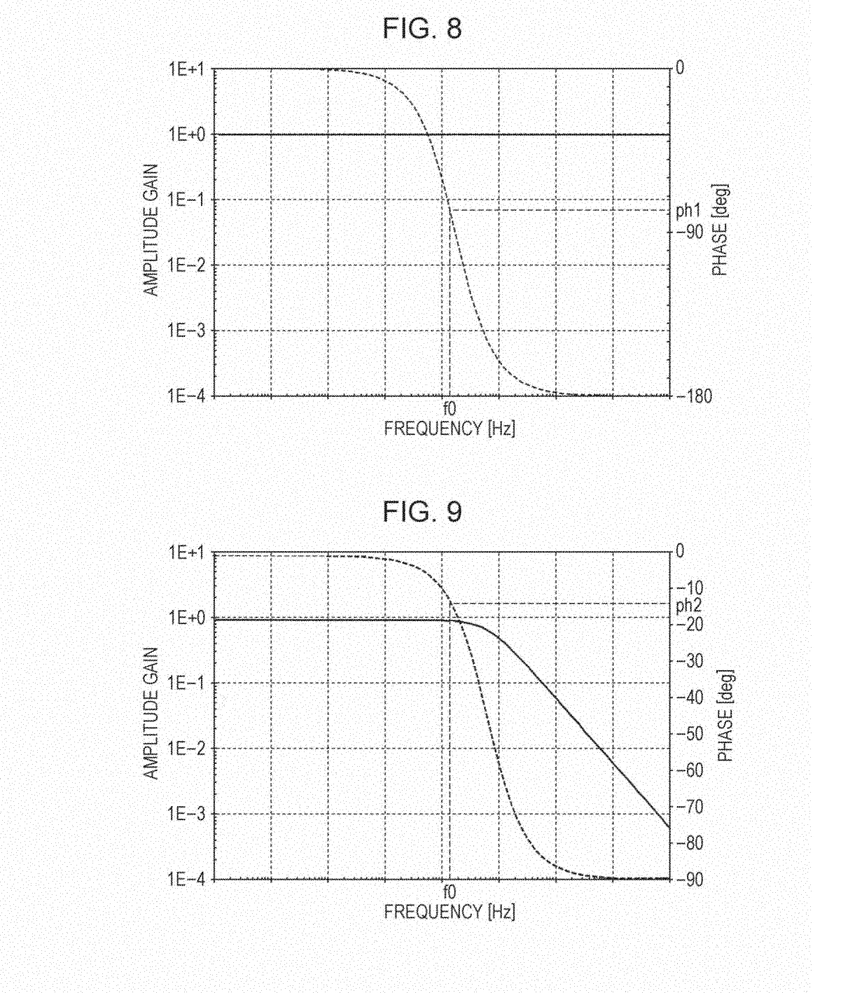

FIG. 8 is a diagram illustrating an example of frequency characteristics of the phase shift circuits 23A and 23B which are all pass filters. In addition, FIG. 9 is a diagram illustrating an example of frequency characteristics of the band limiting filters 24A and 24B which are low pass filters. In FIG. 8 and FIG. 9, solid lines represent the amplitude gain characteristics and dashed lines represent the phase characteristics (the direction of phase lag is negative).

As illustrated in FIG. 8, the amplitude gain in the phase shift circuits 23A and 23B is one regardless of the frequency. In addition, the phase lag in the phase shift circuits 23A and 23B increase as the frequency becomes high, and the range thereof is 0° to 180°.

As illustrated in FIG. 9, the amplitude gain in the band limiting filters 24A and 24B is one in the range from the DC to a predetermined frequency, and decreases as the frequency becomes higher than the predetermined frequency. In addition, the phase lag in the band limiting filters 24A and 24B increases as the frequency becomes high and the range thereof is 0° to 90°.

As illustrated in FIG. 8 and FIG. 9, the phase of the phase shift circuits 23A and 23B at the vibration frequency f0 of the vibration body 112 is ph1, and the phase of the band limiting filters 24A and 24B is ph2. The relationship is indicated as ph1+ph2≅−90°. That is, the sum of the phase lag of the phase shift circuit 23A and the phase lag of the band limiting filter 24A is almost 90°, and the sum of the phase lag of the phase shift circuit 23B and the phase lag of the band limiting filter 24B is almost 90°. The phase advance in the Q/V converter 21A and 21B is 90° (the phase lag is (270°) and the phase lag in the comparator and the level conversion circuit 26 is almost zero. Therefore, the phase lag in the drive loop of the angular velocity detection element 10 becomes 360°, and thus, the condition for vibration becomes satisfied.

As described above, the phase shift circuit 23A and the band limiting filter 24A adjust the phase of the drive signal based on the output signal from the Q/V converter 21A and configure a phase adjustment portion 27A (an example of a first phase adjustment portion) that limits the frequency band of the drive signal. Similarly, the phase shift circuit 23B and the band limiting filter 24B adjust the phase of the drive signal based on the output signal from the Q/V converter 21B and configure a phase adjustment portion 27B (an example of a second phase adjustment portion) that limits the frequency band of the drive signal. In the example in FIG. 7, the phase adjustment portions 27A and 27B are realized by two circuits such as the phase shift circuit 23A and the band limiting filter 24A, or the phase shift circuit 23B and the band limiting filter 24B. However, the phase adjustment portions may be realized by one circuit (for example, a filter using active elements, an LC filter, or the like) that includes a function of adjusting the phase of the AC voltage signal MNT or the AC voltage signal MNTB and a function of limiting the bandwidth.

The output signals from the band limiting filters 24A and 24B are input to the comparator 25. The comparator 25 compares the output voltage (the output signal voltage of the phase adjustment portion 27A) from the band limiting filter 24A and the output voltage (the output signal voltage of the phase adjustment portion 27B) from the band limiting filter 24B, and outputs the mutually reverse-phased square wave signal from the non-inverting output terminal and the inverting output terminal. In the example in FIG. 7, the square wave signal output from the inverting output terminal of the comparator 25 is used as a Coriolis reference signal SDET described below. When the output voltage from the band limiting filter 24A is higher than the output voltage from the band limiting filter 24B, the Coriolis reference signal SDET is in the high level. In addition, when the output voltage from the band limiting filter 24A is lower than the output voltage from the band limiting filter 24B, the Coriolis reference signal SDET is in the low level.

The mutually reverse-phased square wave signals output from the comparator 25 are input to the level conversion circuit 26. The level conversion circuit 26 converts the voltage levels of the output signals from the comparator 25. Specifically, the level conversion circuit 26 converts the mutually reverse-phased square wave signals output from the comparator 25 to the mutually reverse-phased square wave signals having a voltage VH in a case of the high level and a voltage VL in a case of low level. The mutually reverse-phased square wave signals output from the level conversion circuit 26 are respectively input to the fixed drive electrodes 130 and 132 in the angular velocity detection element 10 as the drive signals. The angular velocity detection element 10 is driven by the drive signals input to the fixed drive electrodes 130 and 132.

The circuit configured with the comparator 25 and the level conversion circuit 26 functions as a drive signal generation portion that generates the drive signal which drives the angular velocity detection element 10 based on the output signals from the phase adjustment portions 27A and 27B.

Here, in the embodiment, since it is considered that the current output from the angular velocity detection element 10 which is the electrostatic capacitance type MEMS element is extremely small, the current is received by the Q/V converters 21A and 21B, not by the I/V converter. The currents (the electric charges) output from the angular velocity detection element 10 are accumulated in the capacitors 211A and 211B and sufficiently amplified by the operational amplifiers 210A and 210B. Therefore, the deterioration of the S/N ratio of the output signals from the Q/V converters 21A and 21B can be suppressed, and thus, it is possible to maintain the high S/N ratio.

In addition, as illustrated in FIG. 8 and FIG. 9, the amplitude gain in the phase shift circuits 23A and 23B is one at the vibration frequency f0 of the vibration body 112, and the amplitude gain in the band limiting filters 24A and 24B is almost one also. Therefore, the output signals from the Q/V converter 21A and 21B are output from the band limiting filters 24A and 24B without the amplitude being attenuated. Furthermore, since the band limiting filters 24A and 24B are respectively provided at the stage next to the phase shift circuits 23A and 23B, a high frequency noise generated in the phase shift circuits 23A and 23B can be attenuated by the band limiting filters 24A and 24B. Therefore, in the output signals from the band limiting filters 24A and 24B also, it is possible to maintain the high S/N ratio same as that of the output signals of the Q/V converter 21A and 21B. As a result, the jitter of the drive signal can be reduced, and thus, the jitters of the Coriolis reference signal SDET that interlocks with the drive signal and the quadrature reference signal QDET are decreased.

The angular velocity detection circuit 30 in the embodiment is configured to include two Q/V converters (the charge amplifiers) 31A and 31B, a differential amplifier 32, a Coriolis synchronous detection circuit 33, two quadrature synchronous detection circuits 34A and 34B, two amplitude adjustment circuits 35A and 35B, and two phase adjustment circuits 36A and 36B.

The detection signals (the AC current) output from the fixed detection electrodes 140 and 142 of the angular velocity detection element 10 include the Coriolis signal which is an angular velocity component based on the Coriolis force acting on the angular velocity detection element 10 and the quadrature signal (the leakage signal) which is a self-vibration component based on the excitation vibration of the angular velocity detection element 10. In the quadrature signal (the leakage signal) and the phase of the Coriolis signal (angular velocity component) included in the detection signal output from the fixed detection electrode 140, the phases are shifted to each other by 90°. Similarly, in the quadrature signal (the leakage signal) and the Coriolis signal (the angular velocity component) included in the detection signal output from the fixed detection electrode 142, the phases are shifted to each other by 90°. In addition, the phases of the Coriolis signal (the angular velocity component) included in the detection signals output from the fixed detection electrodes 140 and 142 are mutually reverse-phased, and the phases of the quadrature signals (the leakage signal) are mutually reverse-phased.

The Q/V converter 31A includes an operational amplifier 310A and converts the current output from the fixed detection electrode 140 in the angular velocity detection element 10 and input to the inverting input terminal in the operational amplifier 310A to the voltage. Similarly, the Q/V converter 31B includes an operational amplifier 310B and converts the current output from the fixed detection electrode 142 in the angular velocity detection element 10 and input to the inverting input terminal in the operational amplifier 310B to the voltage.

Specifically, when the vibration body 112 in the angular velocity detection element 10 vibrates, the current based on the change of the capacitance is output from the fixed detection electrodes 140 and 142 and is input to the inverting input terminal of the operational amplifiers 310A and 310B respectively included in the Q/V converters 31A and 31B. The Q/V converter 31A converts the AC current output from the fixed detection electrode 140 to the voltage having the output signals from the amplitude adjustment circuit 35A as the reference, and then, outputs the result. Similarly, the Q/V converter 31B converts the current output from the fixed detection electrode 142 to the voltage having the output signals from the amplitude adjustment circuit 35B as the reference, and then, outputs the result. The signals output from the Q/V converters 31A and 31B are the signals of which the phases are in advance of the AC current output from the fixed detection electrodes 140 and 142 by 90° respectively.

The AC voltage signals output from the Q/V converters 31A and 31B are input to the differential amplifier 32. The differential amplifier 32 performs the differential amplification on the output signal (the AC voltage signal) from the Q/V converter 31A and the output signal (the AC voltage signal) from the Q/V converter 31B, and outputs the result.

The signal output from the differential amplifier 32 is input to the Coriolis synchronous detection circuit 33. The Coriolis synchronous detection circuit 33 performs a synchronous detection on the signal output from the differential amplifier 32 based on the Coriolis reference signal SDET. Specifically, the Coriolis synchronous detection circuit 33 performs a full-wave rectification by selecting the signal output from the differential amplifier 32 when the Coriolis reference signal SDET is in the high level and selects a polarity-inverted signal output from the differential amplifier 32 when the Coriolis reference signal SDET is in the low level, and then, outputs the signal obtained by the rectification after the low pass filter processing. The signal output from the Coriolis synchronous detection circuit 33 is a signal in which the Coriolis signal (angular velocity component) is extracted from the detection signal output from the fixed detection electrodes 140 and 142 in the angular velocity detection element 10, and thus, the voltage of the signal corresponds to the size of the Coriolis signal (the angular velocity component). This signal output from the Coriolis synchronous detection circuit 33 is output to the outside of the angular velocity detection device 1 as the angular velocity signal SO. As described above, the jitter of the Coriolis reference signal SDET is reduced, an accuracy of the synchronous detection by the Coriolis synchronous detection circuit 33 is improved, and as a result thereof, the accuracy of detecting the angular velocity is improved.

The circuit configured with the differential amplifier 32 and the Coriolis synchronous detection circuit functions as an angular velocity signal generation portion that generates the angular velocity signal SO based on the output signals from the Q/V converters 31A and 31B.

The AC voltage signals respectively output from the Q/V converters 31A and 31B are also input to the quadrature synchronous detection circuits 34A and 34B respectively. The quadrature synchronous detection circuit 34A detects the level of the quadrature signal (the leakage signal) included in the AC current output from the fixed detection electrode 140 in the angular velocity detection element 10 based on the output signal (the AC voltage signal) from the Q/V converter 31A. In addition, the quadrature synchronous detection circuit 34B detects the level of the quadrature signal (the leakage signal) included in the AC current output from the fixed detection electrode 142 in the angular velocity detection element 10 based on the output signal (the AC voltage signal) from the Q/V converter 31B.

Specifically, the quadrature synchronous detection circuit 34A performs the synchronous detection on the output signal (the AC voltage signal) output from the Q/V converter 31A based on the quadrature reference signal QDET, and then, detects the level of the quadrature signal (the leakage signal). That is, the quadrature synchronous detection circuit 34A performs a full-wave rectification by selecting the AC voltage signal output from the Q/V converter 31A when the quadrature reference signal QDET is in the high level and selects a polarity-inverted AC voltage signal output from the Q/V converter 31A when the quadrature reference signal QDET is in the low level, and then, outputs the signal obtained by the rectification after the integration processing. The signal output from the quadrature synchronous detection circuit 34A is a signal in which the quadrature signal (the leakage signal) is extracted from the detection signal output from the fixed detection electrode 140 in the angular velocity detection element 10, and thus, the voltage of the signal corresponds to the size of the quadrature signal (the leakage signal).

Similarly, the quadrature synchronous detection circuit 34B performs the synchronous detection on the output signal (the AC voltage signal) output from the Q/V converter 31B based on the quadrature reference signal QDET, and then, detects the level of the quadrature signal (the leakage signal). That is, the quadrature synchronous detection circuit 34B performs a full-wave rectification by selecting the AC voltage signal output from the Q/V converter 31B when the quadrature reference signal QDET is in the high level and selects a polarity-inverted AC voltage signal output from the Q/V converter 31B when the quadrature reference signal QDET is in the low level, and then, outputs the signal obtained by the rectification after the integration processing. The signal output from the quadrature synchronous detection circuit 34B is a signal in which the quadrature signal (the leakage signal) is extracted from the detection signal output from the fixed detection electrode 142 in the angular velocity detection element 10, and thus, the voltage of the signal corresponds to the size of the quadrature signal (the leakage signal). The phases of the signals output from the quadrature synchronous detection circuits 34A and 34B are mutually reverse-phased.

The signals output from the quadrature synchronous detection circuits 34A and 34B are respectively input to the amplitude adjustment circuits 35A and 35B. The amplitude adjustment circuit 35A outputs the signal obtained by adjusting the amplitude of the AC voltage signal MNT according to the output signals from the quadrature synchronous detection circuit 34A such that the quadrature signal (the leakage signal) input to the Q/V converter 31A is cancelled. Similarly, the amplitude adjustment circuit 35B outputs the signal obtained by adjusting the amplitude of the AC voltage signal MNT according to the output signals from the quadrature synchronous detection circuit 34B such that the quadrature signal (the leakage signal) input to the Q/V converter 31B is cancelled. The signals respectively output from the amplitude adjustment circuits 35A and 35B are the AC voltage signals having the frequency same as the vibration frequency (the frequency of the quadrature signal (the leakage signal)), and having the amplitude determined by the size of the quadrature signal (the leakage signal). The AC voltage signals respectively output from the amplitude adjustment circuits 35A and 35B are input to the non-inverting input terminals of the operational amplifiers 310A and 310B respectively included in the Q/V converters 31A and 31B via the phase adjustment circuits 36A and 36B.

The AC voltage signal input to the non-inverting input terminal of the operational amplifier 310A acts so as to cancel the quadrature signal (the leakage signal) included in the current output from the fixed detection electrode 140 in the angular velocity detection element 10 and input to the inverting input terminal of the operational amplifier 310A. Therefore, in the output signals from the Q/V converter 31A, the quadrature signal (the leakage signal) is greatly attenuated. Similarly, the AC voltage signal input to the non-inverting input terminal of the operational amplifier 310B acts so as to cancel the quadrature signal (the leakage signal) included in the current output from the fixed detection electrode 142 in the angular velocity detection element 10 and input to the inverting input terminal of the operational amplifier 310B. Therefore, in the output signals from the Q/V converter 31B, the quadrature signal (the leakage signal) is greatly attenuated. As a result, the offset of the angular velocity signal SO caused by the quadrature signal (the leakage signal) can be reduced. In addition, since the level of the quadrature signal (the leakage signal) included in the output signals from the Q/V converters 31A and 31B is low, the gain of the Q/V converters 31A and 31B can be greatly increases within a range of the output signals from the Q/V converters 31A and 31B not being saturated. Furthermore, in the embodiment as described above, since the jitter of the quadrature reference signal QDET is reduced, the accuracy of the synchronous detection by the quadrature synchronous detection circuits 34A and 34B is improved. As a result, it is possible to improve the S/N ratio of the angular velocity signal SO. Hereinafter, the signal input to the non-inverting input terminal of the operational amplifiers 310A and 310B will be referred to “a quadrature correction signal”.

In some cases, a phase difference between the signals respectively output from the amplitude adjustment circuits 35A and 35B and the detection signals (AC current) respectively input to the inverting input terminals of the operational amplifiers 310A and 310B is shifted from 90° due to the phase lag in the amplitude adjustment circuits 35A and 35B. Therefore, a phase adjustment circuit 36A adjusts the phase of the quadrature correction signal input to the Q/V converter 31A (the non-inverting input terminal of the operational amplifier 310A). In addition, a phase adjustment circuit 36B adjusts the phase of the quadrature correction signal input to the Q/V converter 31B (the non-inverting input terminal of the operational amplifier 310B). Specifically, the phase adjustment circuit 36A adjusts the phase of the quadrature correction signal input to the non-inverting input terminal of the operational amplifier 310A such that the quadrature signal (the leakage signal) input to the Q/V converter 31A is cancelled based on the level of the leakage signal detected by the quadrature synchronous detection circuit 34A. In addition, the phase adjustment circuit 36B adjusts the phase of the quadrature correction signal input to the non-inverting input terminal of the operational amplifier 310B such that the quadrature signal (the leakage signal) input to the Q/V converter 31B is cancelled based on the level of the leakage signal detected by the quadrature synchronous detection circuit 34B. For example, by changing at least one of a resistance value of a variable resistor and a capacitance value of a variable capacitor respectively included in the phase adjustment circuits 36A and 36B according to the levels of each of the output signals of the quadrature synchronous detection circuits 34A and 34B, the amount of phase advance in the phase adjustment circuits 36A and 36B may be changed such that the quadrature signals (the leakage signal) input to the Q/V converters 31A and 31B are cancelled.

The amplitude and the phase of the quadrature correction signals input to the Q/V converter 31A are adjusted by the amplitude adjustment circuit 35A and the phase adjustment circuit 36A such that the level of the output signals from the quadrature synchronous detection circuit 34A is minimized. In this way, a feedback is applied in such a manner that the amplitude of the quadrature signal (the leakage signal) included in the output signals from the Q/V converter 31A is attenuated. Similarly, the amplitude and the phase of the quadrature correction signals input to the Q/V converter 31B are adjusted by the amplitude adjustment circuit 35B and the phase adjustment circuit 36B such that the level of the output signals from the quadrature synchronous detection circuit 34B is minimized. In this way, the feedback is applied in such a manner that the amplitude of the quadrature signal (the leakage signal) included in the output signals from the Q/V converter 31B is attenuated.

As described above, the circuit configured with the quadrature synchronous detection circuit 34A, the amplitude adjustment circuit 35A, and the phase adjustment circuit 36A functions as a first correction signal generation portion that generates the quadrature correction signal (a first correction signal) for reducing the offset of the angular velocity signal SO occurring due to the quadrature signal (the leakage signal) included in the AC current output from the fixed detection electrode 140 of the angular velocity detection element 10 based on the AC voltage signal MNT which a signal based on the drive vibration of the angular velocity detection element 10. In addition, the amplitude adjustment circuit 35A functions as a first amplitude adjustment portion that adjusts the amplitude of the quadrature correction signal based on the level of the quadrature signal (the leakage signal) detected by the quadrature synchronous detection circuit 34A. In addition, the phase adjustment circuit 36A functions as a first phase adjustment portion that adjusts the phase of the quadrature correction signal based on the level of the quadrature signal (the leakage signal) detected by the quadrature synchronous detection circuit 34A.

Similarly, the circuit configured with the quadrature synchronous detection circuit 34B, the amplitude adjustment circuit 35B, and the phase adjustment circuit 36B functions as a second correction signal generation portion that generates the quadrature correction signal (a second correction signal) for reducing the offset of the angular velocity signal SO occurring due to the quadrature signal (the leakage signal) included in the AC current output from the fixed detection electrode 142 of the angular velocity detection element 10 based on the AC voltage signal MNT which a signal based on the drive vibration of the angular velocity detection element 10. In addition, the amplitude adjustment circuit 35B functions as a second amplitude adjustment portion that adjusts the amplitude of the quadrature correction signal based on the level of the quadrature signal (the leakage signal) detected by the quadrature synchronous detection circuit 34B. In addition, the phase adjustment circuit 36B functions as a second phase adjustment portion that adjusts the phase of the quadrature correction signal based on the level of the quadrature signal (the leakage signal) detected by the quadrature synchronous detection circuit 34B.

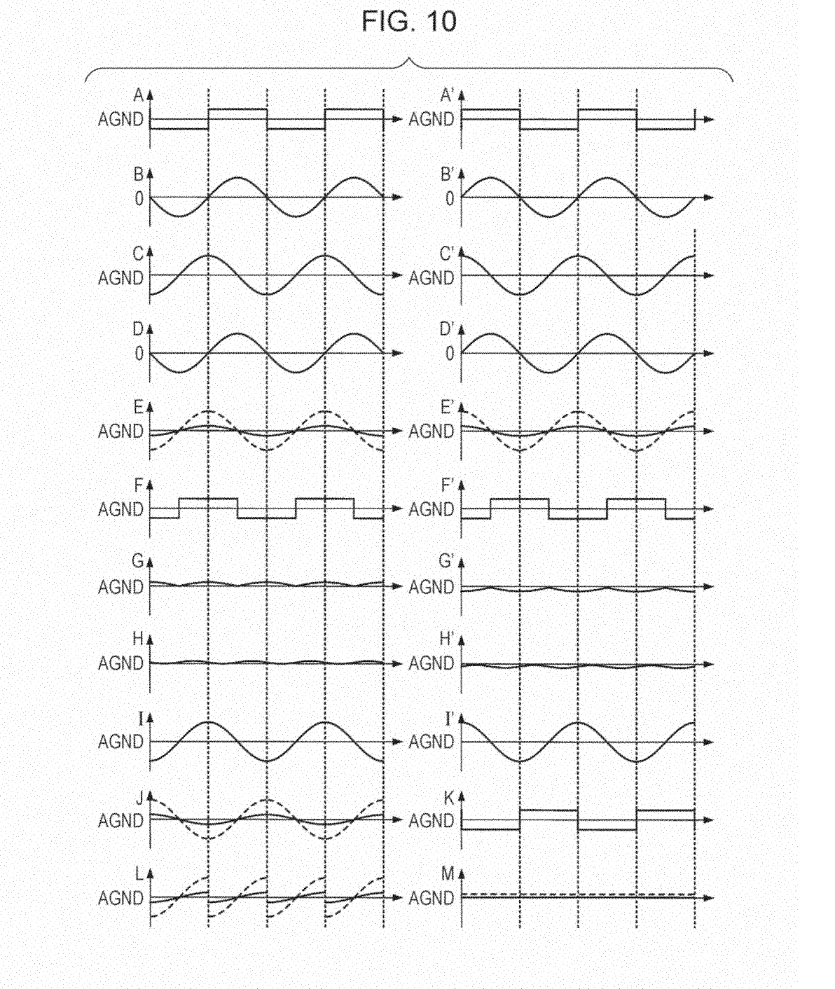

Next, a principle of eliminating the quadrature signal (the leakage signal) using the angular velocity detection device 1 illustrated in FIG. 7 will be described using a waveform diagram in FIG. 10. FIG. 10 is a diagram illustrating an example of the signal waveform from a point A to a point M in FIG. 7, and the horizontal axis represents the time and the vertical axis represents the voltage or the current. FIG. 10 is an example of a case where the Coriolis force is not applied to the angular velocity detection element 10. However, a case where the Coriolis force is applied can also be similarly described.

In a state in which the vibration body 112 in the angular velocity detection element 10 vibrates, the drive signals (signals at the point A and the point A′) output from the level conversion circuit 26 are mutually reverse-phased square waves. In addition, the AC currents (signals at the point B and the point B′) input to the Q/V converters 21A and 21B are mutually reverse-phased and the AC voltage signals MNT and MNTB (signals at the point C and the point C′) output from the Q/V converters 21A and 21B are also mutually reverse-phased. The AC voltage signals MNT and MNTB (the signals at the point C and the point C′) are in advance of the AC currents (the signals at the point B and the point B′) input to the Q/V converters 21A and 21B in phase by 90° respectively.

Since the Coriolis force is not applied to the angular velocity detection element 10, the detection signals (signals at the point D and point D′) input to the Q/V converters 31A and 31B do not include the Coriolis signal and include only the quadrature signal (the leakage signal). The phases of the quadrature signals (the leakage signal) (signals at the point D and point D′) input to the Q/V converters 31A and 31B are mutually reverse, and thus, are the same as that of the AC currents (the signals at the point B and point B′) respectively input to the Q/V converters 21A and 21B.

The quadrature correction signal (a signal at the point I) input to the Q/V converter 31A has a waveform in which the amplitude of the AC voltage signal MNT (the signal at the point C) is adjusted by the amplitude adjustment circuit 35A according to the waveform of the output signals (a signal at the point H) from the quadrature synchronous detection circuit 34A. Similarly, the quadrature correction signal (a signal at the point I′) input to the Q/V converter 31B has a waveform in which the amplitude of the AC voltage signal MNT (the signal at the point C) is adjusted by the amplitude adjustment circuit 35B according to the waveform of the output signals (a signal at the point H′) from the quadrature synchronous detection circuit 34B.

The quadrature correction signal (a signal at the point I point) input to the Q/V converter 31A is in advance of the detection signal (the quadrature signal (the leakage signal)) (the signal at the point D) input to the Q/V converter 31A in phase by 90°, and thus, the quadrature correction signal is added to the AC voltage signal (the signal of which the phase is in advance of the detection signal (the AC current)) by 90° in which the detection signal (the AC current) is converted to the voltage in the Q/V converter 31A. Therefore, the output signals (the signal at the point E) from the Q/V converter 31A have a waveform (waveform in a solid line) in which the amplitude of the quadrature signal (the leakage signal) is attenuated.

Similarly, the quadrature correction signal (a signal at the point I′) input to the Q/V converter 31B is in advances of the detection signal (the quadrature signal (the leakage signal)) (the signal at the point D′) input to the Q/V converter 31B in phase by 90°, and thus, the quadrature correction signal is added to the AC voltage signal (the signal of which the phase is in advance of the detection signal(the AC current)) in which the detection signal (the AC current) is converted to the voltage in the Q/V converter 31B by 90°. Therefore, the output signals (the signal at the point E′) from the Q/V converter 31B have a waveform (waveform in a solid line) in which the amplitude of the quadrature signal (the leakage signal) is attenuated.

In addition, in the quadrature synchronous detection circuit 34A, the signal (the signal at the point G) in which the output signal (the signal at the point E (waveform in a solid line)) from the Q/V converter 31A is full-wave rectified by the quadrature reference signal QDET (the signal at the point F) has a positive waveform of which the amplitude is small. Therefore, the integral signal (the signal at the point H) of the full-wave rectified signal (the signal at the point G) has a low level positive voltage waveform close to DC. The amplitude and the phase of the quadrature correction signal (the signal at the point I) input to the Q/V converter 31A are adjusted by the amplitude adjustment circuit 35A and the phase adjustment circuit 36A such that, for example, the level of the output signals (the signal at the point H) from the quadrature synchronous detection circuit 34A is minimized. In this way, the feedback is applied such that the amplitude of the output signal (the signal at the point E) from the Q/V converter 31A is attenuated.

Similarly, in the quadrature synchronous detection circuit 34B, the signal (the signal at the point G′) in which the output signal (the signal at the point E′ (waveform in a solid line)) from the Q/V converter 31B is full-wave rectified by the quadrature reference signal QDET (the signal at the point F′) has a negative waveform of which the amplitude is small. Therefore, the integral signal (the signal at the point H′) of the full-wave rectified signal (the signal at the point G′) has a low level negative voltage waveform close to DC. The amplitude and the phase of the quadrature correction signal (the signal at the point I′) input to the Q/V converter 31B are adjusted by the amplitude adjustment circuit 35B and the phase adjustment circuit 36B such that, for example, the level of the output signals (the signal at the point H′) from the quadrature synchronous detection circuit 34B is minimized. In this way, the feedback is applied such that the amplitude of the output signal (the signal at the point E′) from the Q/V converter 31B is attenuated.

As a result, in the Coriolis synchronous detection circuit 33, the signal (the signal at point L) in which the output signal (the signal at the point J) from the differential amplifier 32 is full-wave rectified by the Coriolis reference signal SDET (the signal at the point K) has a waveform (wave form in the solid line) with small amplitude repeating to be positive and negative. Therefore, the angular velocity signal SO (the signal at the point M) in which the low pass filter processing is performed on the full-wave rectified signal (the signal at the point L) has a voltage (waveform in a solid line) almost equal to the analog ground voltage AGND even though the symmetry between the positive waveform and the negative waveform in the full-wave rectified signal (the signal at the point L) is slightly shifted. That is, the offset of the angular velocity signal SO occurring due to the quadrature signal (the leakage signal) is extremely small.

Provisionally, in a case where the analog ground voltage AGND is supplied to the non-inverting input terminals of the operational amplifiers 310A and 310B without the quadrature correction signal(the signals at the points I and I′) being supplied, each signal at the points E, E′, J, L, and M has waveform as illustrated in dashed lines in FIG. 10, and thus, the voltage of the angular velocity signal SO (the signal at the point M) is shifted from the analog ground voltage AGND in accordance with the shift of the symmetry between the positive waveform and the negative waveform in the full-wave rectified signal (the signal at the point L). That is, the offset of the angular velocity signal SO occurring due to the quadrature signal (the leakage signal) is large.

### Operational Effects

As described above, according to the angular velocity detection device 1 in the embodiment, in the drive circuit 20, the Q/V converters 21A and 21B convert the current (the electric charges) output from the fixed monitor electrodes 160 and 162 of the angular velocity detection element 10 to the voltage not by causing the current to flow through the resistor but convert the current (the electric charges) to the voltage by accumulating the current (the electric charges) in the capacitors 211A and 211B. Therefore, it is possible to sufficiently amplify the current (the electric charges) despite that the current is small. The signal sufficiently amplified in the Q/V converters 21A and 21B is in advance of the current (the electric charges) output from the fixed monitor electrodes 160 and 162 in phase by 90°. Therefore, in the phase adjustment portions 27A and 27B, the vibration condition can be satisfied after the phase adjustment and the noise component is attenuated by limiting the frequency band, and thus, it is possible to improve the S/N ratio. In addition, the phase shift circuits 23A and 23B are the all pass filters, and the band limiting filters 24A and 24B are the low pass filters. Therefore, when the output signals from the Q/V converters 21A and 21B pass through the phase adjustment portions 27A and 27B, the high frequency noise thereof is attenuated while the amplitude is not attenuated. Furthermore, since the band limiting filters 24A and 24B are provided at the stage subsequent to the phase shift circuits 23A and 23B, when the output signals from the Q/V converters 21A and 21B pass through the phase shift circuits 23A and 23B, the high frequency noise is attenuated by the band limiting filters 24A and 24B even if the high frequency noise generated in the phase shift circuits 23A and 23B is superimposed. Therefore, it is possible to improve the S/N ratio of the output signals from the phase adjustment portions 27A and 27B. Then, the comparator 25 and the level conversion circuit 26 generate the drive signal that drives the angular velocity detection element 10 based on the output signals from the phase adjustment portions 27A and 27B, of which the S/N ratio is improved. Therefore, it is possible to reduce the jitter of the drive signal. As a result, since the jitters of the Coriolis reference signal SDET and the quadrature reference signal QDET are also reduced, it is possible to improve the accuracy of detecting the angular velocity using the angular velocity detection device 1 (the angular velocity detection circuit 30).

In addition, according to the angular velocity detection device 1 in the embodiment, in the drive circuit 20, the phase adjustment of the drive signal using the phase shift circuits 23A and 23B and the limitation of the frequency band of the drive signal using the band limiting filters 24A and 24B can be performed independently. Therefore, it is easy to design the circuit and to realize the reduction of the area of the circuit and stable vibration operation.

### 2. Modification Examples

### 2-1. Modification Example 1

In the embodiment described above, two mutually reverse-phased signals are output from the fixed monitor electrodes 160 and 162 in the angular velocity detection element 10 and are input to the Q/V converters 21A and 21B. However, the configuration may be modified in which the angular velocity detection element 10 does not include the fixed monitor electrode 162 and the Q/V converter 21B is eliminated.

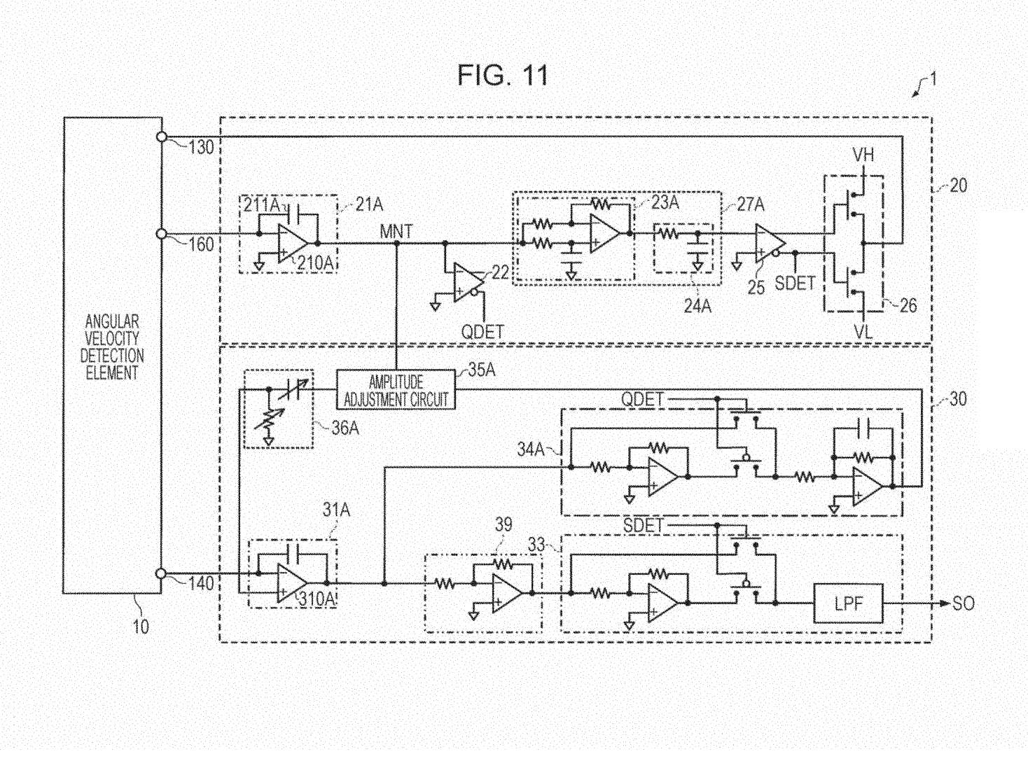

The angular velocity detection device 1 in the modification example 1 is illustrated in FIG. 11. In the angular velocity detection device 1 in the modification example 1 illustrated in FIG. 11, the angular velocity detection element 10 does not include the fixed drive electrode 132, the fixed monitor electrode 162, and the fixed detection electrode 142. Correspondingly, the drive circuit 20 does not include the Q/V converter 21B and the phase adjustment portion 27B, and the configuration of the level conversion circuit 26 is simplified. In addition, the angular velocity detection circuit 30 does not include the Q/V converter 31B, the quadrature synchronous detection circuit 34B, the amplitude adjustment circuit 35B, and the phase adjustment circuit 36B, and the differential amplifier 32 is replaced by an inverting amplifier 39.

According to the angular velocity detection device 1 like this in the modification example 1, it is possible to achieve effects similar to that in the embodiment described above.

### 2-2. Other Modification Examples

In the embodiment described above, the phase shift circuit 23A may be provided at the stage subsequent to the band limiting filter 24A. Similarly, the phase shift circuit 23B may be provided at the stage subsequent to the band limiting filter 24B. In addition, in the embodiment described above, the comparator 25 may not be provided between the phase adjustment portions 27A and 27B and the level conversion circuit 26, or may be configured such that the output signals from the phase adjustment portions 27A and 27B are directly input to the level conversion circuit 26.

### 3. Electronic Apparatuses

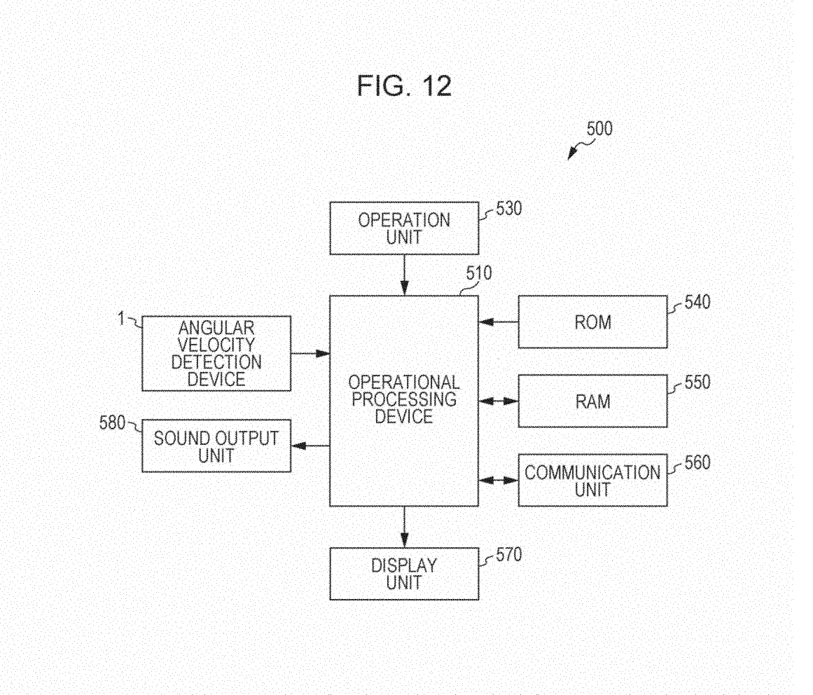

FIG. 12 is a functional block diagram of an electronic apparatus 500 in the embodiment. The same reference signs will be given to the similar configuration elements in each embodiment described above, and the descriptions thereof will be omitted.

The electronic apparatus 500 in the embodiment is an electronic apparatus 500 including the angular velocity detection device 1. In the example illustrated in FIG. 12, the electronic apparatus 500 is configured to include the angular velocity detection device 1, an operational processing device 510, an operation unit 530, a read only memory (ROM) 540, a random access memory(RAM) 550, a communication unit 560, a display unit 570, and a sound output unit 580. A part of the configuration elements (each unit) illustrated in FIG. 12 in the electronic apparatus 500 in the embodiment may be omitted or changed, or other configuration elements may be added to the configuration.

The operational processing device 510 performs various operational processing items or the control processing items according to a program stored in the ROM 540 or the like. Specifically, the operational processing device 510 performs processing items such as various processing items according to the output signals from the angular velocity detection device 1 or the operation signals from the operation unit 530, the processing for controlling the communication unit 560 for performing the data communications with the outside, the processing for transmitting the display signals for displaying various information items on the display unit 570, and the processing for outputting various sounds to the sound output unit 580.

The operation unit 530 is an input device configured with operation keys and button switches, and outputs an operation signal by the user's operation to the operational processing device 510.

The ROM 540 stores a program or the data for the operational processing device 510 to perform various operational processing items or the control processing items.

The RAM 550 is used as a work area of the operational processing device 510 and temporarily stores the program or the data read out from the ROM 540, the data input from the operation unit 530, and the result of operation performed by the operational processing device 510 according to various programs.

The communication unit 560 performs various controls for establishing the data communications between the operational processing device 510 and the external device.

The display unit 570 is a display device configured with a liquid crystal display (LCD), an electrophoresis display, or the like, and displays various information items based on the display signal input from the operational processing device 510.

The sound output unit 580 is device such as a speaker that outputs sounds.

According to the electronic apparatus 500 in the embodiment, since the apparatus includes the angular velocity detection device 1 capable of improving the accuracy of detecting the angular velocity, it is possible to realize the electronic apparatus 500 which is capable of performing the processing (for example, control according to a posture or the like) based on the change of the angular velocity with a high accuracy.

Various electronic apparatuses can be considered as the electronic apparatus 500. Examples of the apparatuses can include a personal computer (for example, a mobile type personal computer, a lap top type personal computer, a tablet type personal computer), a mobile terminal such as a mobile phone, a digital camera, an ink jet type discharging device (for example, an ink jet printer), a storage area network device such as routers and switches, a local area network device, a base station device for the mobile terminal, a television set, a video camera, a video recorder, a car navigation system, a pager, an electronic notebook (including communication functions), an electronic dictionary, a calculator, an electronic game machine, a game controller, a word processor, a workstation, a TV phone, a television monitor for security, electronic binoculars, a point of sale (POS) terminal, medical devices (for example, an electronic thermometer, a blood pressure monitor, a blood glucose meter, an electrocardiogram measurement device, an ultrasonic diagnostic device, an electronic endoscope), a fish finder, various measuring instruments, instruments (for example, instruments in a vehicle, an aircraft, or a ship), a flight simulator, a head mount display, a motion trace device, a motion tracking device, a motion controller, and a PDR (pedestrian position azimuth measurement).

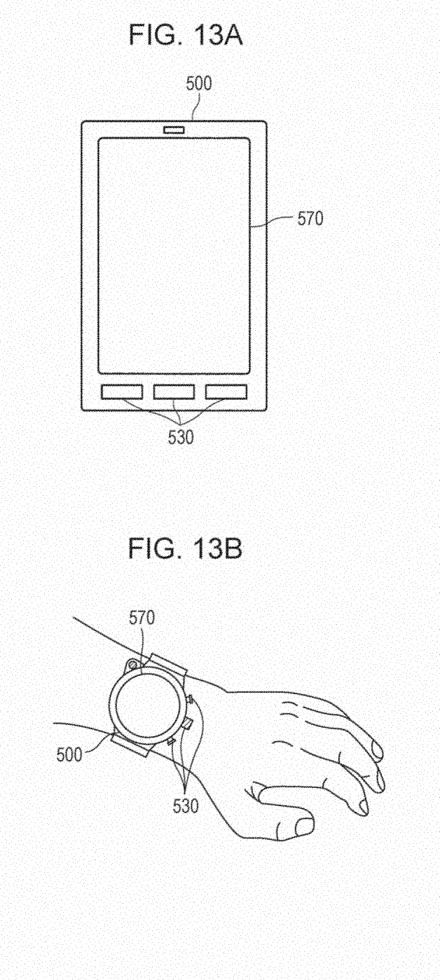

FIG. 13A is a diagram illustrating an example of an external view of a smart phone which is an example of the electronic apparatus 500 and FIG. 13B is a diagram illustrating an example of an external view of a wrist-wearable type mobile device which is an example of the electronic apparatus 500. The smart phone which is the electronic apparatus 500 illustrated in FIG. 13A includes buttons as the operation unit 530 and an LCD as the display unit 570. The wrist-wearable type mobile device which is the electronic apparatus 500 illustrated in FIG. 13B includes buttons and a crown as the operation unit 530 and an LCD as the display unit 570. These electronic apparatuses 500 are configured to include the angular velocity detection device 1 capable of improving the accuracy of detecting the angular velocity. Therefore, it is possible to realize the electronic apparatus 500 which is capable of performing the processing (for example, control according to a posture or the like) based on the change of the angular velocity with a high accuracy.

### 4. Moving Object

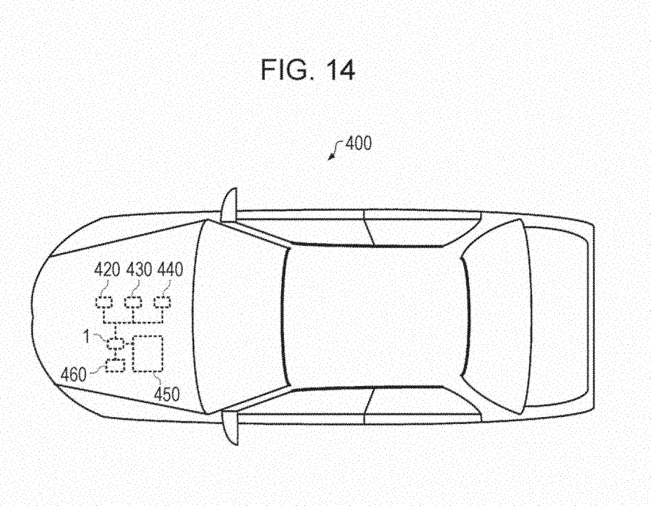

FIG. 14 is a diagram (top view) illustrating an example of a moving object 400 in the embodiment. The same reference signs will be given to the similar configuration elements described in each embodiment above, and the description thereof will be omitted.

The moving object 400 in the embodiment is the moving object 400 that includes the angular velocity detection device 1. In the example illustrated in FIG. 14, the moving object 400 is configured to include a controller 420 that performs various controls such as an engine system, a brake system, and a keyless entry system, a controller 430, a controller 440, a backup battery 450, and a backup battery 460. A part of the configuration elements (each unit) illustrated in FIG. 14 in the moving object 400 in the embodiment may be omitted or changed, or other configuration elements may be added to the configuration.

According to the moving object 400 in the embodiment, since the moving object 400 includes the angular velocity detection device 1 which is capable of improving the accuracy of detecting the angular velocity, it is possible to realize the moving object 400 which is capable of performing the processing (for example, control for suppressing a sideslip or an overturn) based on the change of the angular velocity with a high accuracy.

Various moving objects can be considered as the moving object 400 and the examples may include automobiles (including an electric vehicle), aircrafts such as a jet aircraft and a helicopter, ships, rockets, and satellites, and the like.

The invention is not limited to the present embodiment, and various modifications can be embodied within the scope of the invention.

The embodiment and the modification example described above are just examples, the invention is not limited thereto. For example, each embodiment and each modification example may be appropriately combined.

The invention includes the configuration substantially the same as the configuration (for example, a configuration having the same function, method and result, or a configuration having the same object and the effect) described in the embodiment. In addition, the invention includes a configuration in which non-essential parts of the configuration described in the embodiment are replaced. In addition, the invention includes configurations that achieve the same effects or configurations that can achieve the same object as the configurations described in the embodiments. In addition, the invention includes a configuration in which a known technique is added to the configuration described in the embodiment.

The entire disclosure of Japanese Patent Application No. 2016-042348, filed Mar. 4, 2016 is expressly incorporated by reference herein.

What is claimed is:

1. A drive circuit comprising:
a first converter that includes a first operational amplifier and a first capacitance, accumulates first signals output from a first electrode of an angular velocity detection element and input to the first operational amplifier in the first capacitance, and then, converts the signals to a voltage;
a first phase adjustment portion that adjusts a phase of the drive signal which drives the angular velocity detection element and limits a frequency band of the drive signal based on the output signals from the first converter; and
a drive signal generation portion that generates the drive signal based on the output signals from the first phase adjustment portion.

2. The drive circuit according to claim 1,
wherein the first phase adjustment portion includes a first phase shift circuit for adjusting the phase of the drive signal and a first filter for limiting the frequency band of the drive signal.

3. The drive circuit according to claim 2,
wherein the first phase shift circuit is an all pass filter.

4. The drive circuit according to claim 2,
wherein the first filter is a low pass filter.

5. The drive circuit according to claim 2,
wherein the first filter is provided at a stage subsequent to the first phase shift circuit.

6. The drive circuit according to claim 1, further comprising:
a second converter that includes a second operational amplifier and a second capacitance, accumulates second signals output from a second electrode of the angular velocity detection element and input to the second operational amplifier in the second capacitance, and then, converts the signals to a voltage; and
a second phase adjustment portion that adjusts a phase of the drive signal and limits a frequency band of the drive signal based on the output signals from the second converter,
wherein the drive signal generation portion generates the drive signal based on the output signals from the first phase adjustment portion and the output signals from the second phase adjustment portion.

7. The drive circuit according to claim 6,
wherein the drive signal generation portion includes;
a comparator that compares a voltage of the output signal from the first phase adjustment portion and the voltage of the output signal from the second phase adjustment portion, and
a level conversion circuit that converts a voltage level of the output signals from the comparator and generates the drive signal.

8. An angular velocity detection device comprising:
the drive circuit according to claim 1;
an angular velocity detection circuit that receives a detection signal output from the angular velocity detection element and generates an angular velocity signal; and
the angular velocity detection element.

9. An electronic apparatus comprising the angular velocity detection device according to claim 8.

10. A moving object comprising the angular velocity detection device according to claim 8.
